(19) United States
(12) Patent Application Publication
(10) Pub. No.: US 2026/0041020 A1
(43) Pub. Date: Feb. 12, 2026

(54) CULTIVATOR WITH FINGER WEEDERS

(71) Applicant: Accura Flow, LLC, Pulaski, IA (US)

(72) Inventor: Isaac Martin, Jr., Pulaski, IA (US)

(73) Assignee: Accura Flow, LLC, Pulaski, IA (US)

(21) Appl. No.: 19/293,996

(22) Filed: Aug. 7, 2025

Related U.S. Application Data
(60) Provisional application No. 63/680,836, filed on Aug. 8, 2024.

(51) Int. Cl. A01B 39/22; A01B 39/08

(52) U.S. Cl. CPC A01B 39/22; A01B 39/08

(57) ABSTRACT

A cultivator includes at least one cultivator row unit, each of the at least one cultivator row unit includes a frame, a support assembly operatively connected to the frame for securing the cultivator row unit to a tool bar, a shank operatively connected to the frame and configured to support an earth working tool, and a finger weeder tool operatively connected to the frame and mounted such that the finger weeder tool engages ground forward of the shank.

### RELATED APPLICATIONS

This application claims priority to U.S. Provisional Ser. No. 63/680,836 , filed Aug. 8, 2024, herein incorporated by reference in its entirety.

### FIELD OF THE INVENTION

The present invention relates generally to agricultural equipment. More particularly, but not exclusively, the present invention relates to agricultural equipment with finger weeders.

### BACKGROUND

To assist in understanding the present invention and its need, problems regarding cultivators are discussed. It is to be understood, however, that aspects of the present invention may be applied in other applications or other types of machinery.

Cultivators are generally used to kill weeds in a field of crop by disturbing topsoil in a manner which buries the leaves of the weeds and/or uproots them. In recent times, cultivators have been used sparingly and instead of using cultivators, crop producers have focused their efforts on using herbicide weed control and genetically modified organism (GMO) crops with herbicide resistant traits.

Some crop producers have recognized advantages in growing non-GMO or organic crops. Others have had fields where it is not economically viable to apply herbicides in specific situations. In either instance, weed control is needed and thus there is a need for cultivators. Ideally, cultivators should knock over, bury, or uproot weeds without knocking over, burying, or uprooting crops. However, in practice this is very difficult to achieve due to a variety of variables.

Therefore, what is needed is improved agricultural equipment such as an improved cultivator to better address weeds within a field.

### SUMMARY

Therefore, it is a primary object, feature, or advantage to improve over the state of the art.

It is a further object, feature, or advantage to provide a cultivator with finger weeders.

Another object, feature, or advantage is to provide a cultivator with finger weeders mounted at the front of the implement.

Yet another object, feature, or advantage it to provide cutaways discs in front of finger weeders in order to cut a trench on both sides of a row to remove soil prior to finger weeders, thereby removing resistance encountered by the finger weeders.

A still further object, feature, or advantage is to use the finger weeders prior to shovels or other earth working tools thus that the finger weeders may function to lay down the weeds and allow the soil to flow over the weeds to cover the weeds.

Yet another object, feature or advantage is to provide a cultivator which provides accurate control of the flow of soil into a row.

A further object, feature, or advantage is to provide a cultivator which assists in controlling weeds by burying the weeds with a controlled flow of soil.

A still further object, feature, or advantage is to provide a cultivator with a rolling shield.

It is a still further object, feature, or advantage to provide a cultivator which is effective at weed control.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

According to one aspect, a cultivator includes at least one cultivator row unit, each of the at least one cultivator row unit having a support assembly for securing the cultivator row unit to a tool bar, a first shank, a first earth working tool operatively connected at a first end of the first shank for placement next to a first row of a crop, a gauge wheel assembly operatively connected to the support assembly, the gauge wheel assembly comprising a first gauge wheel, an arm extending from the support assembly; a first finger weeder tool rotatably mounted at a front of the support assembly following the gauge wheel assembly such that the gauge wheel assembly sets a depth for the first finger weeder tool, the first finger weeder tool positioned such that in operation, the first earth working tool follows the first finger weeder tool, and the first finger weeder tool comprising a central portion and a plurality of fingers extending outwardly therefrom.

According to another aspect, a cultivator includes at least one cultivator row unit, each of the at least one cultivator row unit includes a frame, a support assembly operatively connected to the frame for securing the cultivator row unit to a tool bar, a shank operatively connected to the frame and configured to support an earth working tool, and a finger weeder tool operatively connected to the frame and mounted such that the finger weeder tool engages ground forward of the shank.

According to another aspect, a cultivator includes at least one cultivator row unit, each of the at least one cultivator row unit includes a support assembly for securing the cultivator row unit to a tool bar, a gauge wheel assembly operatively connected to the support assembly, a cutaway disc mounted forward of and operatively connected to the support assembly, and a finger weeder tool rotatably mounted to the support assembly and positioned rearward of the cutaway disc, the finger weeder tool comprising a central portion and a plurality of fingers extending outwardly therefrom, wherein the gauge wheel assembly sets a depth for the finger weeder tool. The cultivator further includes a shank operatively connected to the support assembly and positioned rearward of the finger weeder tool and an earth working tool operatively connected to the shank. In operation, the cutaway disc cuts a trench in soil to reduce resistance encountered by the finger weeder tool, the finger weeder tool engages ground forward of the earth working tool to lay down weeds, and the earth working tool moves soil to flow over the weeds laid down by the finger weeder tool. The cutaway disc is positioned to cut a trench on both sides of a crop row to remove soil prior to the finger weeder tool engaging the ground. The cultivator may further include a rolling shield operatively connected to the support assembly and positioned to control soil flow into a crop row, wherein the rolling shield is positioned rearward of the earth working tool. The finger weeder tool may be angled downwardly and outwardly towards a crop row such that the plurality of fingers penetrate soil and lift dirt to uproot small weeds close to the crop row. The gauge wheel assembly may include a first gauge wheel and a second gauge wheel, and wherein the gauge wheel assembly is positioned forward of the finger weeder tool to set the depth at which the finger weeder tool extends into soil.

### BRIEF DESCRIPTION OF THE DRAWINGS

Illustrated embodiments of the disclosure are described in detail below with reference to the attached drawing figures, which are incorporated by reference herein.

FIG. 1 illustrates one view of a cultivator row unit mounted on a toolbar.

FIG. 2 is another partial view of the cultivator row unit.

FIG. 3 is a view of the cultivator with a plurality of row units.

FIG. 4 is another view of the cultivator row unit secured to a tool bar with finger weeder tools present.

### DETAILED DESCRIPTION

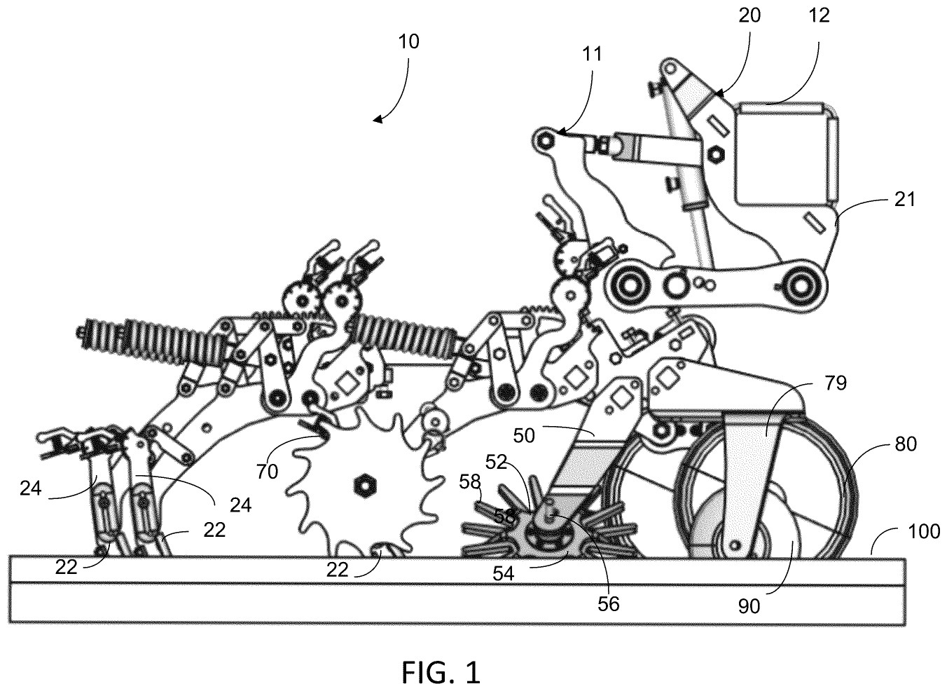

FIG. 1 illustrates one view of a cultivator row unit 10 having a frame 11 and mounted on a toolbar 12. A main support assembly 20 is shown. The support assembly may include a bracket assembly 21 for securing the frame 11 of the cultivator row unit 10 to the toolbar 12. It is contemplated that the cultivator row unit 10 may be secured to the toolbar 12 in any number of different ways and that the bracket assembly may have different shapes and geometries.

The cultivator row unit 10 includes a plurality of different shovels, sweeps, points, or other earth working tools 22. Although the term “sweep” is generally used herein it is to be understood that a sweep is merely one type of earth working tool and other types of earth working tools may be used as may be appropriate for particular field conditions. Each of the sweeps 22 is mounted to a different shank 24.

In the cultivator row unit 10 shown, various quick adjustments are shown which provide incremental adjustment. The incremental adjustment associated with the meshing of gears allows for a limited number of discrete positions to be selected from. This is advantageous in that while permitting a sufficient number of possible positions, it may facilitate making adjustments easier within the same row unit or between different row units. It also greatly simplifies the adjustment process for the operator so that they can better keep track of the position and can more easily return to a desired setting if desired. The adjustments shown may be of the type shown in U.S. Pat. No. 11,707,009 to Martin, hereby incorporated by reference in its entirety and provide for quick and incremental adjustment of the working depth of the gauge wheel(s) 80 of the gauge wheel assembly 79, the depth earth working tool 22, and the angle of the sweep 22 or other earth working tool.

An arm 50 extends from the frame 11. Mounted on the arm 50 is a finger weeder tool 52 or finger weeder. The finger weeder tool 52 is rotatably mounted to rotate around a central axis 54. The finger weeder tool 52 has a hub or central portion 56 and a plurality of fingers 58 extending outwardly from the central portion 56. The finger weeder tool 52 may be positioned such that it is angled outwardly and downwardly into the soil or ground 100. The angle of the finger weeder tool 52 may be adjusted based on the size of the weeds and the crop stage. Thus, fingers 58 on the finger weeder tool 52 may extend towards a row of the crop. The fingers 58 penetrate and lift dirt thereby uprooting small weeds close to the row, especially small weeds close to the base of the plants (crop) without damaging them.

Note that the finger weeder tool 52 is mounted such that the finger weeder tool 52 engages the ground 100 forward of any of the earth working tools 22 attached at the shanks 24. The finger weeder tool 52 is mounted rearward of a cutaway disc 90 and the gauge wheel 80. The gauge wheel(s) may be used to adjust the depth at which the finger weeder tool 52 extends into the soil.

This configuration of having a forward mounted finger weeder tool 52 is advantageous in improving performance of the cultivator. The cutaway disc 90 cuts weeds and creates a trench in the soil which improves the ability of the finger weeder to perform as it goes into the soil near the row. Thus, use of the finger weeder tool 52 in such a configuration improves the ability to control weeds within the row due to the improved flow of soil, with the shanks and earth working tool 22 separated from the crop row with a rolling shield 70 following. The finger weeder tool 52 is close to the row crop to move dirt into the row of crop, to further cover up any small weeds within the row. Thus, in this configuration, the finger weeder tool 52 may remove weeds by uprooting the weeds within a row or close to within a row and the flow of soil is controlled in order to direct soil into the plants within the row to cover up weeds present.

Each cutaway disc 90 is in front of the finger weeder tool 52 in order to cut a trench on both sides of a row to remove soil prior to the finger weeder tool 52. This removal of soil in front of the finger weeders removes resistance which would otherwise be encountered by the finger weeders.

The finger weeder tool 52 is in front of shovels or other earth working tools 22. Thus, the finger weeder tools 52 may function to lay down the weeds and then the shovel or other earth working tool 22 moves soil to flow over the weeds to cover the weeds. Thus, the finger weeder tool 52 may disturb and rip out weeders prior to the shovels or other earth working tool 22.

The rolling shield 70 is used to stop soil flow into a row of crop. Although the rolling shield 70 is shown for the central earth working tools 22, it may also be used for the rearward earth working tools 22. The rolling shield 70 is rotatable mounted and may be supported with an arm on a spring. In a normal position, the rolling shield 70 may be above the ground and not rotating unless there is sufficient soil flow. The rolling shield may turn very easily once soil is sufficient to engage the rolling shield 70 and this adds further control to the soil flow.

Rearward of the rolling shield 70 are additional shanks and earth working tools 22 in the middle of the row to assist in further covering up any weeds. Although these rearward most earth working tools 22 are not shown with rolling shields, rolling shields may also be added.

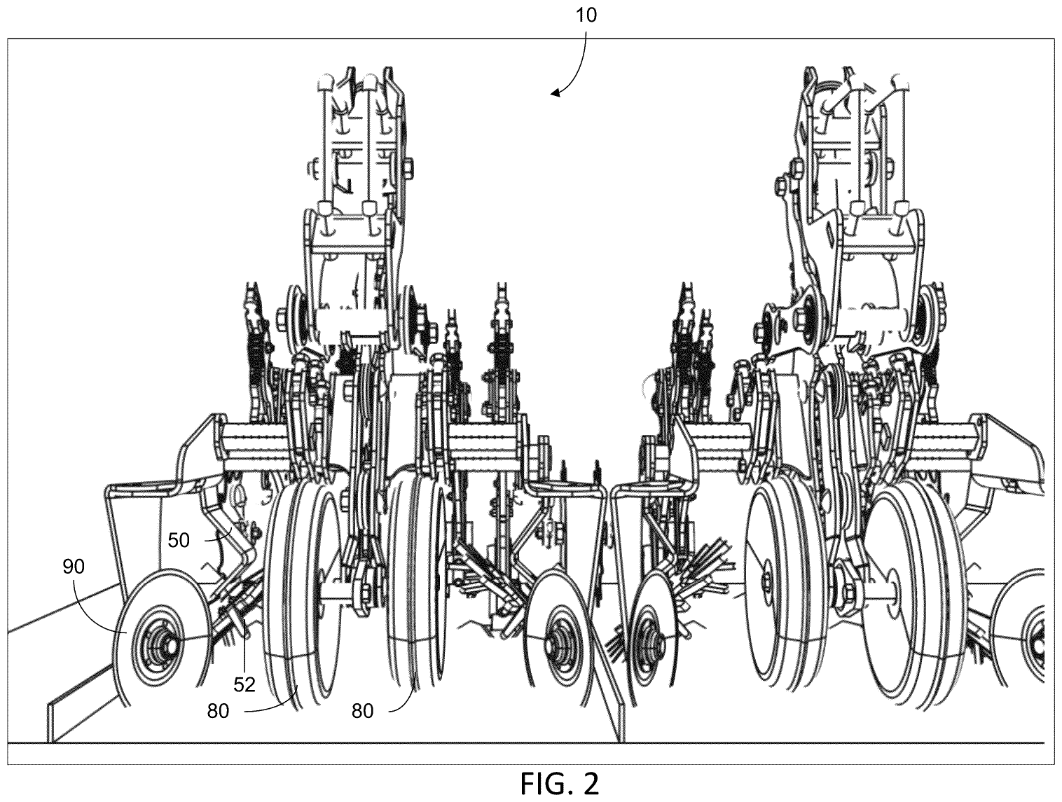

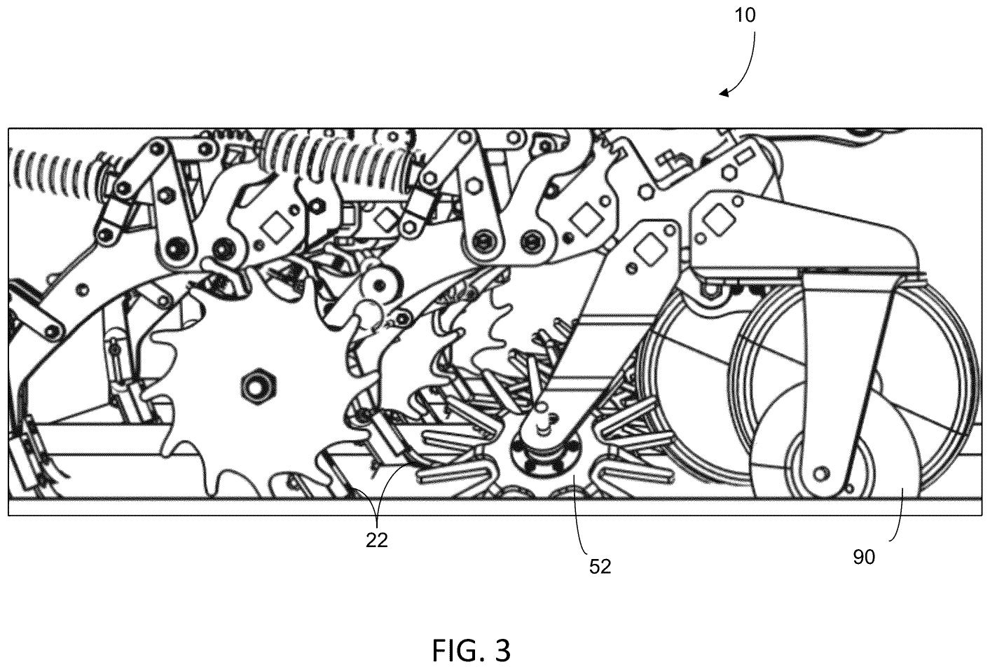

FIG. 2 illustrates another view from the front of the cultivator showing multiple or cultivator row units 10. FIG. 3 shows a further view of the cultivator to further illustrate the earth working tools 22 and their relative position to the finger weeder tool 52.

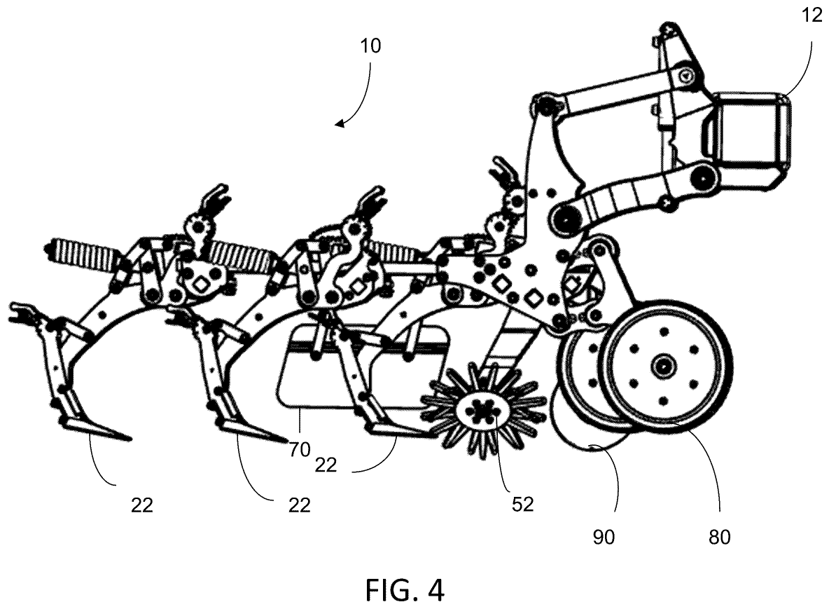

FIG. 4 provides another view of the cultivator row unit 10 secured to a tool bar 12 with finger weeder tools 52 present. Note that the forward positioning of the finger weeder tools 52. The depth of the gauge wheels 80 control the depth of the finger weeder tools 52. The cutaway disc 90 provides for pre-trenching to reduce finger weeder resistance. This arrangement allows for coordinated soil flow control throughout the operational sequence.

In some embodiments, down force may be applied to the finger weeder tool 52 and/or other components of the cultivator row unit 10 through various mechanisms to ensure consistent ground engagement across varying field conditions. In one embodiment, a spring-loaded down force assembly may be operatively connected between the support assembly and the arm supporting the finger weeder tool 52, providing adjustable downward pressure to maintain proper soil penetration depth even when encountering hard or compacted soil conditions. Alternatively, a hydraulic or pneumatic down force system may be employed, with cylinders operatively connected to the support assembly 20 to provide variable down force that can be adjusted based on soil conditions, crop stage, or weed pressure. The down force system may also include pressure sensors or feedback mechanisms to automatically adjust the applied force based on ground conditions, ensuring optimal finger weeder performance while preventing excessive soil disturbance or crop damage. Additionally, the gauge wheel assembly may be configured with its own adjustable down force mechanism, such as a spring or hydraulic system, to maintain consistent depth control reference for the finger weeder tool 52. The down force may be applied independently to different components (finger weeder tool, cutaway disc 90, earth working tools 22) or collectively through a master down force system that distributes pressure across multiple components based on predetermined ratios or operator-selected settings. The downforce may be set for each row separately. The downforce may be applied individually for each row. In some embodiments section control with downforce is also provided to provide for point row cultivation. Hydraulic system may be used to lift each row unit separately to provide point row cultivation.

Although a cultivator and assemblies have been shown and described, it is to be understood that various options and alternatives are contemplated. This includes, for example, variations in the size, shape, and type of earth working tools, finger weeder tools, and other variations. This further contemplates the presence or absence of quick adjustment assemblies, s, whether a single or dual gauge wheels are used, the type and number of earth working tools, the number of row units, the distance the earth working tools trail the toolbar, the manner in which row units are secured to a tool bar, and other variations.

The invention is not to be limited to the particular embodiments described herein. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes, or methods of the invention. It is understood that any other modifications, substitutions, and/or additions can be made, which are within the intended spirit and scope of the invention.

What is claimed is:

1. A cultivator comprising at least one cultivator row unit, each of the at least one cultivator row unit comprising:
a support assembly for securing the cultivator row unit to a tool bar;
a first shank;
a first earth working tool operatively connected at a first end of the first shank for placement next to a first row of a crop;
a gauge wheel assembly operatively connected to the support assembly, the gauge wheel assembly comprising a first gauge wheel;
an arm extending from the support assembly;
a first finger weeder tool rotatably mounted at a front of the support assembly following the gauge wheel assembly such that the gauge wheel assembly sets a depth for the first finger weeder tool, the first finger weeder tool positioned such that in operation, the first earth working tool follows the first finger weeder tool;
the first finger weeder tool comprising a central portion and a plurality of fingers extending outwardly therefrom.

2. The cultivator of claim 1 further comprising at least one cutaway disc mounted forward of the first finger weeder tool.

3. The cultivator of claim 1 further comprising additional shanks and earth working tools rearward of the first shank.

4. The cultivator of claim 1 wherein the first finger weeder tool is angled downwardly and outwardly towards the first row of the crop.

5. The cultivator of claim 1 wherein the gauge wheel assembly further comprises a second gauge wheel.

6. The cultivator of claim 1 wherein the first earth working tool is a first sweep.

7. The cultivator of claim 1 further comprising a rolling shield associated with the first shank.

8. A cultivator comprising at least one cultivator row unit, each of the at least one cultivator row unit comprising:
a frame;
a support assembly operatively connected to the frame for securing the cultivator row unit to a tool bar;
a shank operatively connected to the frame and configured to support an earth working tool;
a finger weeder tool operatively connected to the frame and mounted such that the finger weeder tool engages ground forward of the shank.

9. The cultivator of claim 8 wherein the finger weeder tool is angled downwardly and outwardly towards a row of crop.

10. The cultivator of claim 9 wherein the earth working tool is a sweep.

11. The cultivator of claim 8 further comprising a gauge wheel assembly operatively connected to the frame, the gauge wheel assembly comprising a first gauge wheel positioned forward of the at least one finger weeder tool.

12. The cultivator of claim 11 wherein the first gauge wheel is used in setting depth of the at least one finger weeder tool.

13. The cultivator of claim 12 wherein the gauge wheel assembly further comprises as second gauge wheel.

14. The cultivator of claim 8 further comprising at least one cutaway disc positioned forward of the at least one finger weeder tool.

15. The cultivator of claim 8 further comprising a rolling shield associated with shank.

16. A cultivator comprising at least one cultivator row unit, each of the at least one cultivator row unit comprising:
a support assembly for securing the cultivator row unit to a tool bar;
a gauge wheel assembly operatively connected to the support assembly;
a cutaway disc mounted forward of and operatively connected to the support assembly;
a finger weeder tool rotatably mounted to the support assembly and positioned rearward of the cutaway disc, the finger weeder tool comprising a central portion and a plurality of fingers extending outwardly therefrom, wherein the gauge wheel assembly sets a depth for the finger weeder tool;
a shank operatively connected to the support assembly and positioned rearward of the finger weeder tool; and
an earth working tool operatively connected to the shank;
wherein in operation, the cutaway disc cuts a trench in soil to reduce resistance encountered by the finger weeder tool, the finger weeder tool engages ground forward of the earth working tool to lay down weeds, and the earth working tool moves soil to flow over the weeds laid down by the finger weeder tool.

17. The cultivator of claim 16, wherein the cutaway disc is positioned to cut a trench on both sides of a crop row to remove soil prior to the finger weeder tool engaging the ground.

18. The cultivator of claim 16, further comprising a rolling shield operatively connected to the support assembly and positioned to control soil flow into a crop row, wherein the rolling shield is positioned rearward of the earth working tool.

19. The cultivator of claim 16, wherein the finger weeder tool is angled downwardly and outwardly towards a crop row such that the plurality of fingers penetrate soil and lift dirt to uproot small weeds close to the crop row.

20. The cultivator of claim 16, wherein the gauge wheel assembly comprises a first gauge wheel and a second gauge wheel, and wherein the gauge wheel assembly is positioned forward of the finger weeder tool to set the depth at which the finger weeder tool extends into soil.
